(19) United States
(12) Patent Application Publication
(10) Pub. No.: US 2008/0208396 A1
(43) Pub. Date: Aug. 28, 2008

(54) Mission Control System and Vehicle Equipped with the Same

(75) Inventors: Domenico Cairola, Torrazza Piemonte (IT); Filippo D'Antoni, Roma (IT)

Correspondence Address: OSTROLENK FABER GERB & SOFFEN, 1180 AVENUE OF THE AMERICAS, NEW YORK, NY, 100368403, US

(73) Assignee: GALILEO AVIONICA S.P.A., Campi Bisenzio (IT)

(21) Appl. No.: 10/559,494

(22) PCT Filed: Jun. 7, 2004
(86) PCT No.: PCT/IB04/01841

§ 371 Date: Mar. 12, 2008

(30) Foreign Application Priority Data
Jun. 6, 2003 (IT) TO2003A000426

(51) Int. Cl. G06F 17/00; G09G 5/00

(52) U.S. Cl. 701/3; 701/1; 345/8

(57) ABSTRACT

There is described a mission control system having an operator seat; a head-mounted display and digital gloves worn by the operator; a headset having a microphone and integrated in the head-mounted display; a tracker for tracking the movements of the head-mounted display and the digital gloves; and a mission computer housed in the operator seat and connected to the head-mounted display, to the digital gloves, to the headset, to the microphone, and to the tracker, to allow the operator to impart gestural commands by means of the digital gloves, and voice commands by means of the microphone, and to receive visual information by means of the head-mounted display, and audio information by means of the headset.

### TECHNICAL FIELD

The present invention relates to a mission control system, and to a vehicle equipped with the same.

The present invention may be used to particular advantage, though not exclusively, in airborne surveillance systems, to which the following description refers purely by way of example.

The present invention may also be used to advantage in any application requiring a mission operator work station, be it a work station on board a mission vehicle, such as a fixed- or rotary-wing surveillance aircraft, submarine, or tank, or a ground work station for mission vehicle remote control.

### BACKGROUND ART

On the basis of experience acquired developing numerous airborne surveillance systems, the Applicant has determined several critical areas common to all applications requiring a mission operator work station.

Foremost of these are:
tactical information availability;
installation of mission control systems on small aircraft;
data security; and
connectivity.

As regards tactical information availability, in a modern mission control system, the data collected by the numerous on-vehicle sensors and generated by the mission computer is presented to the operator in a highly integrated form by one or two conventional liquid-crystal screens, the size of which depends on the mission control system installation environment; and the events to be kept track of by the operator in the course of the mission are communicated by on-screen graphic symbols and indicator lights at the work station. Given the nature of the events and the normally heavy work load of the operator, mission events may not always be perceived and interpreted as fast and accurately as they should be. Moreover, interaction between the operator and the mission control system is mainly by means of an alphanumeric keyboard and a pointer, with all the limitations this involves:
slow command entry;
limited degree of instinctive response;
uncomfortable work environment (vibration, etc.);
distraction of the user's attention from the screen to operate the keyboard.

For the above reasons, and in view of the ever-increasing amount of information gathered by mission sensors, and hence the increasing number of events to be kept track of, it is essential that operators be provided with a more efficient interface to maximize mission effectiveness and enable prolonged missions with as small a crew as possible.

As regards installation on very small aircraft, conventional mission control systems are unsuitable for installation in cramped environments, mainly on account of the size and weight of the component parts of the system. Though considerable progress has been made in this direction with the introduction of liquid-crystal screens and miniaturized electronics, serious limitations still exist, particularly as regards man-machine interface control equipment.

As regards data security, user access to conventional mission control systems is protected by a password, which has several major drawbacks:
user-selected passwords are easy to guess; recent studies, in fact, show a 90% probability of unauthorized system access;
pseudo-random, system-generated passwords are safer but, being difficult to remember, are often written down, thus defeating the object;
passwords can be “spied” when keyed-in;
passwords are not altogether personal, by being “loanable”.

As regards connectivity, mission control systems, particularly for military applications or agency use, traditionally comprise equipment, both hardware and software, specially designed for specific applications. This poses serious drawbacks as regards communication and data exchange with other, standard, equipment, such as that widely used in operating bases or ordinary laboratories and data analysis centres. That is, in the case of on-board computers equipped with dedicated operating systems, it is highly unlikely that data gathered during the mission can be shared and analysed quickly and effectively using an ordinary portable computer, or be distributed over a communication network.

### DISCLOSURE OF INVENTION

It is an object of the present invention to provide a mission control system, and a vehicle equipped with such a mission control system, designed to eliminate the aforementioned drawbacks.

According to the present invention, there is provided a mission control system, as claimed in Claim 1.

According to the present invention, there is also provided a vehicle equipped with a mission control system, as claimed in Claim 17.

### BRIEF DESCRIPTION OF THE DRAWINGS

A preferred, non-limiting embodiment of the present invention will be described by way of example with reference to the accompanying drawings, in which:

FIG. 1 shows a mission control system in accordance with the present invention;

FIGS. 2 and 3 show an operator seat forming part of the mission control system;

FIG. 4 shows, schematically, the layout of the mission control system component parts inside the operator seat, and the electric wiring of the mission control system;

FIG. 5 shows a block diagram of the mission control system.

### BEST MODE FOR CARRYING OUT THE INVENTION

In FIGS. 1 to 5, number 1 indicates as a whole a mission control system in accordance with the present invention installed on a vehicle 2 (shown schematically) of the type referred to previously.

Mission control system 1 substantially comprises:
an operator seat 3 with armrests;
a mission computer 4;
a head-mounted display (HMD) 5;
digital gloves 6;
a tracker 7;
a headset 8 with a microphone 9;
a keyboard 10;
a trackball pointer 11;
a hand control 12;
a biometric identifier 13; and
a liquid-crystal display (LCD) 14.

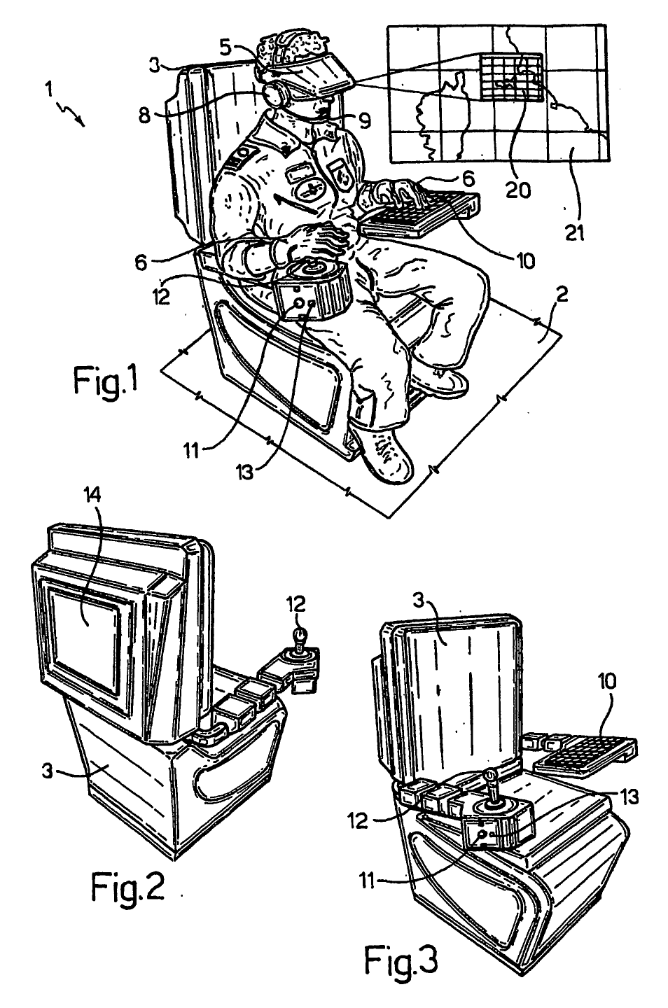

FIGS. 2 and 3 show operator seat 3, which is conveniently made of aluminium and carbon or glass fibre, is divided into two separate parts, and has removable armrests for fast, easy on-vehicle installation. Operator seat 3 comprises a number of compartments, formed underneath the seat portion and in the backrest, for housing all the hardware of mission control system 1; and terminal boards 15 (I/O ports and connectors) for the connection of removable filing and other peripherals (GPRS, sensors, etc.).

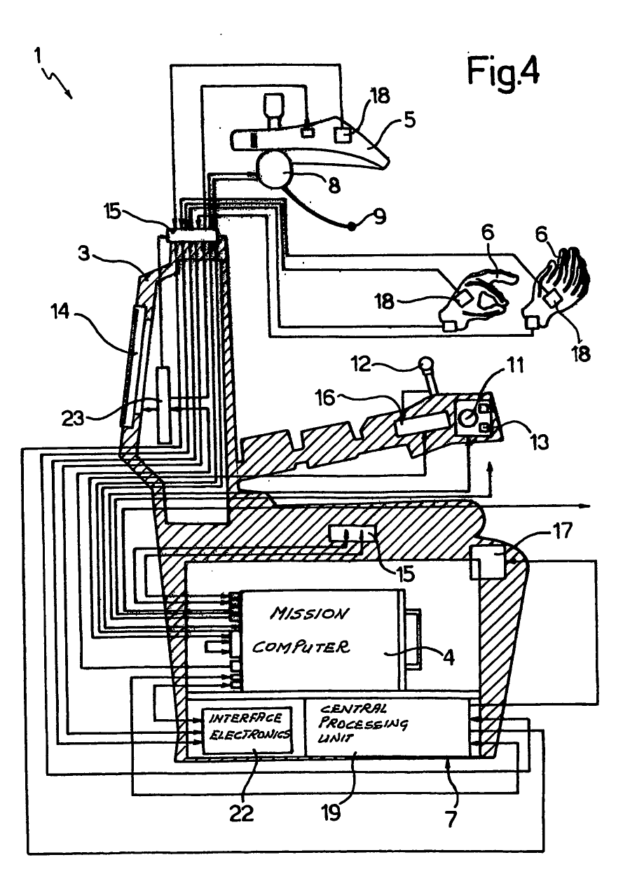

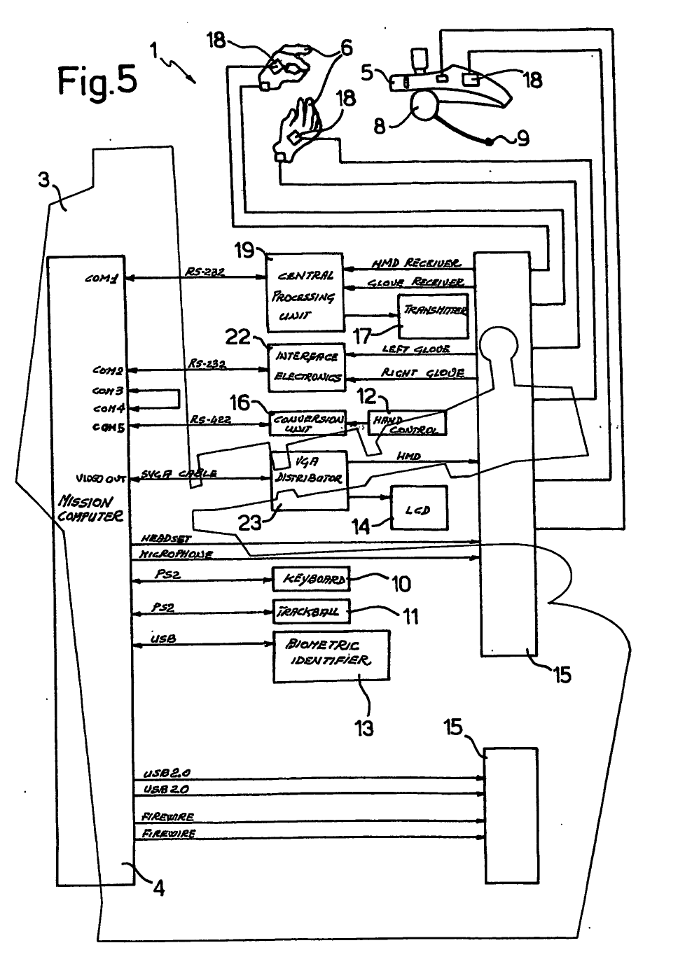

The electric wiring of mission control system 1 is shown schematically in FIG. 4; and FIG. 5 shows a block diagram of mission control system 1 illustrating the electric connections of the various devices forming part of mission control system 1, and the type of electric connections.

As shown in FIGS. 4 and 5, mission computer 4 is housed inside one of the compartments formed underneath the seat portion of operator seat 3, and is connected to all the other devices forming part of mission control system 1. More specifically, mission computer 4 controls all the functions of mission control system 1, and is manufactured using hardware in conformance with the most advanced, widely adopted commercial standards, with electromechanical provisions to ensure maximum performance and compactness compatible with the strict environmental requirements typical of military applications.

Keyboard 10, conveniently backlighted and foldable, is integrated in the left armrest of operator seat 3, while hand control 12, trackball pointer 11, and biometric identifier 13 are integrated in the right armrest of operator seat 3.

Besides controlling the user interface in known manner, keyboard 10 and trackball pointer 11 may also be used as back-up devices to digital gloves 6, and may be removed if necessary.

Hand control 12 is substantially defined by a joystick having a number of control elements (buttons, knobs, etc.), and provides for controlling devices incorporating electrooptical sensors. In surveillance applications, in fact, electrooptical sensors for target detection, location and identification are indispensable.

The operator commands imparted by hand control 12 are picked up by a grip conversion unit 16 and transmitted to mission computer 4 by an RS-422 expansion board.

Biometric identifier 13 is used for security access to mission control system 1, and can also be used for coding any type of file so that it can only be decoded when accessed by authorized operators.

The technology of biometric identifier 13 may vary, depending on the type of installation. For example, biometric identifiers 13 may be used based on:
fingerprint recognition with a capacitive or capacitive/optical sensor;
retina scan recognition;
face profile recognition.

A suitable biometric identifier 13, for example, is the BIOTOUCH USB200 fingerprint sensor manufactured by IDENTIX, which is an optical biometric sensor with a CMOS-based microchamber capable of recognizing a profile even in the presence of damp, dirt, or injury, and which has the following characteristics:
17×17 mm work area;
530×380 dpi resolution;
operation independent of fingertip rotation.

The above sensor model provides for greater protection by identifying a number of fingerprints, and loading a number of personal user profiles, which are useful, for example, for more extensive applications than voice recognition. Mission control system access by each operator is thus fast and intuitive, and the text and mission report dictation function can be set by automatically loading the operator's personal profile.

If necessary, to further improve security of mission control system 1, an additional biometric identifier (not shown) may be provided in HMD 5 to perform an operator retina scan.

A liquid-crystal display (LCD) 14 is installed behind the backrest of operator seat 3 to relay the video signal on HMD 5 for the benefit of other crew members; and a VGA signal amplifier and distributor 23 is provided inside the compartment in the backrest of operator seat 3 to amplify and distribute the video signals to both HMD 5 and LCD 14.

Tracker 7 is defined by a transmitter 17 housed underneath the seat portion of operator seat 3; by three receivers 18, one connected to HMD 5, and the other two to digital gloves 6; and by a central processing unit 19 housed in one of the compartments underneath the seat portion of operator seat 3, and connected on one side to transmitter 17 and receivers 18, and on the other side to mission computer 4 via an RS232 interface.

Providing receivers 18 on both digital gloves 6 permits both right- and left-handed operation of mission control system 1.

Transmitter 17 and receivers 18 interact to track operator head and hand movements to a measuring precision of around a hundredth of an inch, and so permit intuitive, gesture-coded user-video interface control.

Interaction between transmitter 17 and receivers 18 may, for example, be electromagnetic, bearing in mind, however, that the particular type of technology adopted always depends on the characteristics and environmental requirements of the specific application for which mission control system is used.

A suitable electromagnetically operated tracker 7, for example, is the FASTRACK tracker manufactured by POLHEMUS, with the following characteristics:
real-time electromagnetic tracking with 6 degrees of freedom;
0.03″ (0.15°) precision;
0.0002″ (0.025°) resolution;
360° coverage to a radius of over 3 metres.

HMD 5 substantially comprises an ergonomic helmet weighing roughly 1 kg and equipped with two liquid-crystal screens, and provides for controlling a much larger virtual work area (desktop) than that actually displayed on the liquid-crystal screens.

FIG. 1 shows the virtual desktop 21 accessible by head movement of the operator, and the window 20 shown each time on HMD 5.

Navigation within virtual desktop 21 is made possible by tracker 7, which acquires information relative to the head movement of the operator, and translates the display window 20 in the detected movement direction.

The particular technology of HMD 5 also provides, when necessary, for displaying three-dimensional tactical scenarios to provide the operator with information at a much higher level than that obtainable using conventional screens.

A suitable HMD 5, for example, is the PRO VIEW XL-35 manufactured by KAISER ELECTRO-OPTICS, with the following characteristics:
active-matrix TFT display with 1024×768 resolution;
35° viewing range;
compatible with eye glasses;

1 designed for stereoscopic vision.

Digital gloves 6 allow the operator to interact with mission control system 1, and provide for improved performance as compared with conventional pointers, such as a mouse or trackball, as well as for simple, intuitive, gesture-coded control.

More specifically, the three, horizontal, vertical and longitudinal, translation components of digital gloves 6 are picked up and interpreted by tracker 7 to move the cursor on virtual desktop 21.

Selection and action events (right, middle, left click/double click) are performed by combinations of electric contacts on the surface of digital gloves 6, between the fingers, and are picked up by interface electronics 22 connected to digital gloves 6 and to mission computer 4.

Suitable digital gloves 6, for example, are PINCH GLOVES manufactured by FAKESPACE, which operate by closing electric contacts on each finger and on the palm of the hand, permit natural gesticulation, and require no setting.

The display-operator head movement dependence function and the gesture coding function can be activated or deactivated by gesture coding or voice command.

When not in use, digital gloves 6 and HMD 5 are stowed in a compartment (not shown) formed underneath the seat portion of operator seat 3.

Headset 8, complete with microphone 9, is incorporated in the helmet also comprising HMD 5, and permits operator voice control of mission control system 1, and reception of mission and system status information. Voice synthesis and recognition are removable filing peripherals, such as palmtops, laptops, USB keys, memory readers, or hard disks, connectable to mission computer 4 by a USB 2.0, or IEEE1394 firewire, or Bluetooth interface, and which combine intrinsic structural strength, by being typically “movable”, with high-speed data transfer.

Connection of mission control system 1 to ground control units, such as laptop PC's or a straightforward palmtop, is made over Bluetooth wireless communication channels, i.e. with no wiring required between the on-vehicle system and ground unit.

Low transmission power and, consequently, limited operating range, combined with the use of appropriate coding algorithms, ensure safe data transfer.

The advantages of mission control system 1 according to the present invention will be clear from the foregoing description.

As regards the user interface in particular, the mission control system according to the invention provides for performing commonly used operator functions faster and with greater ease.

The HMD, in fact, provides a tactical scenario display which, as opposed to being limited in size by the resolution and characteristics of the display device, can be explored as a function of operator head movements, and is represented in greater detail by virtue of a third virtual dimension; and the digital gloves and the voice commands imparted by means of the microphone headset resolution and characteristics of the display device, can be explored as a function of operator head movements, and is represented in greater detail by virtue of a third virtual dimension; and the digital gloves and the voice commands imparted by means of the microphone headset permit fast, intuitive interaction between the operator and mission control system 1.

All the service and alarm messages of the mission control system are communicated by sound messages, by means of a voice synthesizer, inside the microphone headset, thus reducing the work load of the operator who is no longer forced to continually consult indicator lights and/or service menus.

As regards size, the mission control system according to the present invention is designed for maximum function integration, so that size and weight can be minimized to adapt to normally critical environments, such as very small aircraft and helicopters. The technologies employed enable all the component parts of the mission control system to be housed inside the operator seat, so the system can even be installed where there is normally only room for one passenger.

The mission control system according to the invention also solves numerous installation problems, such as installing equipment supports and electric wiring, and many others.

The mission control system according to the invention provides for greatly improving data security, by being accessed by a biometric identifier ensuring greater security as compared with traditional passwords, and which only permits access in the actual presence of the authorized user.

Even filed data is protected by biometric identification, thus ensuring security even when the data “leaves” the system, e.g. for ground filing or computer network distribution.

As regards connectivity, the mission control system according to the invention permits mission data exchange, over both wired and wireless connections, with portable external devices (notebooks, palmtops, portable solid-state storage units, etc.) conforming with commonly used electronic standards, so that mission data can be filed easily and made immediately available to ground-station operators.

Clearly, changes may be made to mission control system 1 as described and illustrated herein without, however, departing from the scope of the present invention, as defined in the accompanying Claims.

In particular, the component parts of the mission control system may be produced using a wide range of technologies to adapt to different environments and working conditions.

1) A mission control system, wherein by comprising:
an operator station;
a head-mounted display worn by an operator;
digital gloves worn by the operator;
a tracker for tracking the movements of said head-mounted display and said digital gloves; and
a mission computer housed in said operator station and connected to said head-mounted display, to said digital gloves, and to said tracker, to allow the operator to impart gestural commands by means of said digital gloves, and to receive visual information by means of said head-mounted display.

2) A system as claimed in claim 1, wherein by also comprising:
a headset worn by the operator; and
a microphone worn by the operator;
said headset and said microphone being connected to said mission computer to allow the operator to impart voice commands by means of said microphone, and to receive audio information by means of said headset.

3) A system as claimed in claim 1, wherein that said headset and said microphone are integrated in said head-mounted display.

4) A system as claimed in claim 1, wherein that said head-mounted display displays a window movable within a larger work window in response to movements of the head-mounted display.

5) A system as claimed in claim 1, wherein that said operator station comprises an operator seat having a compartment for housing said mission computer.

6) A system as claimed in claim 5, wherein that said operator seat has a further compartment for housing said head-mounted display and said digital gloves.

7) A system as claimed in claim 1, wherein by also comprising:
a hand control fitted to said operator station and connected to said mission computer to permit remote control of electrooptical devices.

8) A system as claimed in claim 7, wherein that said hand control comprises a joystick integrated in a first armrest of said operator seat.

9) A system as claimed in claim 1, wherein by also comprising:
a pointer fitted to said operator station and connected to said mission computer.

10) A system as claimed in claim 9, wherein that said pointer is a trackball, and is integrated in said first armrest of said operator seat.

11) A system as claimed in claim 1, wherein by also comprising:
a biometric sensor fitted to said operator station and connected to said mission computer to permit access to the mission control system by authorized operators.

12) A system as claimed in claim 1, wherein by also comprising:
a keyboard connected to said mission computer and fitted to said operator station.

13) A system as claimed in claim 12, wherein that said keyboard is integrated in a second armrest of said operator seat.

14) A system as claimed in claim 1, wherein by also comprising interface means for connection of removable external filing devices.

15) A system as claimed in claim 1, wherein that said tracker comprises:
a transmitter housed in said operator station;
two receivers associated respectively with said head-mounted display and at least one of said digital gloves; and
a central processing unit connected to said transmitter and to said receivers to track the movements of said head-mounted display and said digital gloves.

16) A system as claimed in claim 1, wherein by also comprising:
a display fitted to the rear face of said operator seat and used as a repeater to relay the images displayed on said head-mounted display.

17) A vehicle, wherein by comprising a mission control system as claimed in claim 1.

18) A vehicle as claimed in claim 17, wherein by comprising a fixed- or rotary-wing aircraft.
